(19) United States
(12) Patent Application Publication
(10) Pub. No.: US 2009/0294699 A1
(43) Pub. Date: Dec. 3, 2009

(54) METHOD FOR INFLUENCING AN ENERGY STATE OF A RADIATION SOURCE

(76) Inventor: Volker Schaft, Hamburg (DE)

Correspondence Address: MCCORMICK, PAULDING & HUBER LLP, CITY PLACE II, 185 ASYLUM STREET, HARTFORD, CT, 06103, US

(21) Appl. No.: 12/465,208

(22) Filed: May 13, 2009

(30) Foreign Application Priority Data
May 28, 2008 (EP) 08 009 685.2-2208

(51) Int. Cl. G01J 3/10

(52) U.S. Cl. 250/504 R

(57) ABSTRACT

A method is provided for influencing an energy state of a radiation source. In order to provide a method that in a simple manner influences the energy state of a radiation source in a high-pressure metal vapour lamp, for the increase or decrease of the energy of the radiation source at least one energy sink is introduced into the direction of propagation of the electromagnetic radiation the radiation sources.

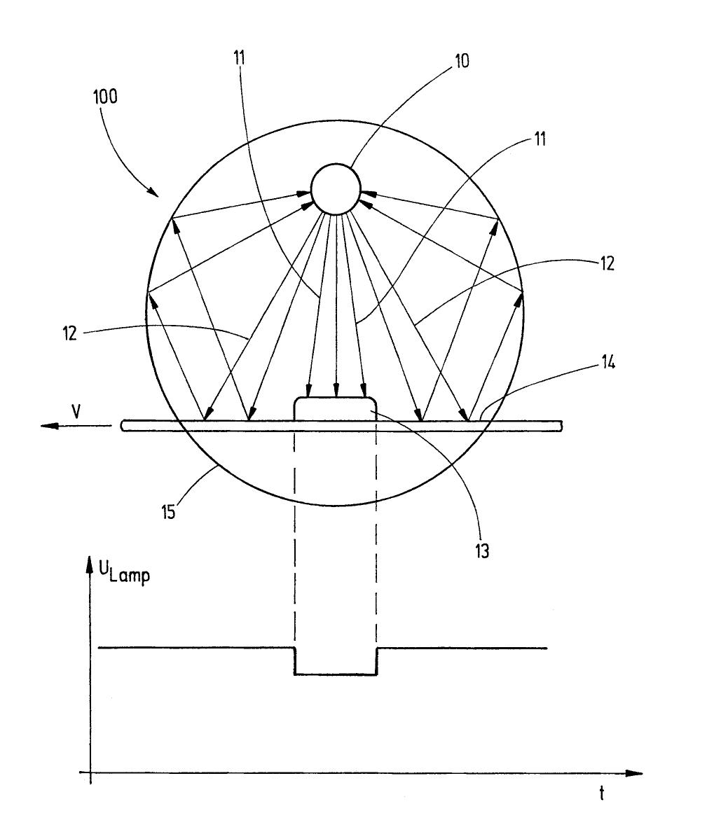

### CROSS REFERENCE TO RELATED APPLICATION

This application claims the benefit of European Application No. 08 009 685.2-2208, filed on May 28, 2008, entitled “A Method for Influencing an Energy State of a Radiation Source”, the disclosure of which is hereby incorporated by reference in its entirety.

### FIELD OF THE INVENTION

The invention concerns a method for influencing an energy state of a radiation source.

In addition the invention concerns a device for influencing an energy state of a radiation source.

### BACKGROUND OF THE INVENTION

Methods of the type cited in the introduction are of known art from the prior art, wherein these however have not so far been considered for high-pressure vapour discharge lamps. High-pressure metal vapour lamps such as mercury vapour lamps are in turn to be cited here; these continue to find widespread usage as light sources.

It is therefore the object of the invention to make available a method of the kind described in the introduction, which in a simple manner influences the energy state of a radiation source in a high-pressure metal vapour lamp.

### SUMMARY OF THE INVENTION

The invention places the interaction of matter and radiation at the focus of the considerations. In accordance with the invention, at least one energy sink is brought into the direction of propagation of the electromagnetic radiation of the radiation source for purposes of increasing and decreasing the energy of the radiation source. In the terminology used here a material body is identified as an energy sink, which body interacts with the electromagnetic radiation of a radiation source and towards which body the energy flux of the radiation source flows.

Surprisingly it has been shown experimentally that just the introduction of an energy sink (body) into the electromagnetic field of a radiation source of a gas discharge lamp influences the parameters of the plasma such as temperature and pressure. Here a temperature reduction, i.e. a decrease in the energy of the radiation source, can also occur.

A test to analyse the invention can be made to the effect that just the introduction of an energy sink, for example a metal body, into the direction of propagation of electromagnetic radiation from a radiation source such as a plasma gap in a mercury vapour lamp elicits a disturbance of the radiation source that manifests itself in an immediate alteration of the energy state, such as a decrease in the energy of the radiation source.

Advantageously the radiation source is formed in the shape of a plasma gap. A radiation source in the form of a plasma gap can be found, for example, in gas discharge lamps, so that the method according to the invention can be introduced in particular into gas discharge lamps.

The subject of the invention is in addition a device for influencing an energy state of a radiation source, wherein for purposes of increasing or decreasing the energy of the radiation source at least one energy sink is arranged in the direction of propagation of the electromagnetic radiation from the radiation source.

The method according to the invention and the device according to the invention are particularly suited to gas discharge lamps. Accordingly the invention also foresees the application of the method and/or the device in a gas discharge lamp.

The invention is elucidated in more detail in what follows with the aid of the FIGURE. In a schematic representation:

### BRIEF DESCRIPTION OF THE DRAWING

The FIGURE shows a method according to the invention.

### DETAILED DESCRIPTION OF THE PREFERRED EMBODIMENT

According to the method represented in the FIGURE electromagnetic radiation 11, 12 emanates from a radiation source 10, which in the form of embodiment represented here is a plasma gap in a device 100. The device 100 is provided with a wall 15. An energy sink 13 is introduced into the direction of propagation of the electromagnetic radiation 11. As a result an interaction occurs between radiation source 10 and energy sink 13. The experiment now shows that this interaction in turn has an effect on the energy state of the radiation source 10. Part of the electromagnetic radiation in the form of the radiation 12 impinges onto the carrier material 14, on which the energy sink 13 is located. It has been experimentally demonstrated that the arrangement of the energy sink 13 in the direction of propagation of the electromagnetic radiation 11 can also result in a decrease of the energy of the radiation source 10.

Thus it has been shown that the temperature of the radiation source 10 present as a plasma gap alters inversely to the energy sink 13, if the energy sink 13 is introduced into the direction of propagation of the electromagnetic radiation 11 of the energy sink 13. Here the energy flux between radiation source 10 and energy sink 13 is in existence only for as long as the energy sink, which in the form of embodiment shown here is provided as a UV colour in the form of a substrate, i.e. as a UV reactive compound, is in the focus of the energy source 10. If on the other hand just the carrier material 14 is in the focus of the radiation source 10, then a large part of the radiation source 12 is reflected and also creates an altered energy state of the plasma.

A practical implementation of the method can be effected such that the energy sink 13 influences the radiation source 10 so strongly that the alteration can be used as a control parameter (cf. on this matter: U_{Lamp}-t diagram). Here the radiation source 10 can also be used as a receiver and the energy propagation can be controlled such that only defined energy sinks 13 are irradiated. If one moreover assumes that in coating processes, for example, substrates are always applied in a recurrent sequence, one can furthermore evaluate the disturbances of the radiation source 10 caused in succession by the energy sink 13 as velocity signals. In this manner a disturbance signal can be evaluated and used both as a control signal and as the time parameter of the radiation source 10.

The present invention is not limited in its form of embodiment to the preferred example of embodiment described above. Rather a number of variants can be conceived, which also make use of the solution represented in terms of fundamentally different types of embodiments. Thus, for example, further energy sinks 13 can be arranged between radiation source 10 and energy sink 13, onto which sinks the electromagnetic radiation (11) impinges.

1. A method for influencing an energy state of a radiation source, comprising the step of introducing at least one energy sink into the direction of propagation of the electromagnetic radiation of a radiation source for the increase or decrease of the energy of the radiation source.

2. The method according to claim 1, further comprising the step of forming the radiation source in the shape of a plasma gap.

3. A device for influencing an energy state of a radiation source, the device comprising at least one energy sink arranged in the direction of propagation of the electromagnetic radiation of a radiation source for the increase or decrease of the energy of the radiation source.

4. The device according to claim 3, wherein the energy sink is a UV-reactive compound.

5. The device according to claim 3, wherein the radiation source is a plasma gap.

6. The use of a method according to claim 1 in a gas discharge lamp.

7. The use of a device according to claim 3 in a gas discharge lamp.
